(19) United States
(12) Patent Application Publication
(10) Pub. No.: US 2020/0162215 A1
(43) Pub. Date: May 21, 2020

(54) PILOT SIGNALS

(71) Applicant: JRD COMMUNICATION (SHENZHEN) LTD, Nanshan Shenzhen, Guangdong (CN)

(72) Inventors: Umer SALIM, Nanterre (FR); Sebastian WAGNER, Nanterre (FR); Bruno JECHOUX, Nanterre (FR)

(21) Appl. No.: 16/607,702

(22) PCT Filed: Aug. 9, 2018
(86) PCT No.: PCT/CN2018/099517

§ 371 Date: Oct. 23, 2019

(30) Foreign Application Priority Data
Aug. 11, 2017 (GB) 1712891.9

(51) Int. Cl. H04L 5/00; H04W 72/04; H04L 27/26

(52) U.S. Cl. CPC H04L 5/0048; H04L 5/0007; H04L 27/2613; H04L 5/0053; H04W 72/042

(57) ABSTRACT

Methods and systems for the use of pilot signals are described. Multiple pilot signals (DMRS) may be transmitted within a mini-slot to allow for fast changing channels and long mini-slots. DMRS structures are described which have reduced frequency resource usage.

### TECHNICAL FIELD

The current disclosure relates to pilot signals in OFDM transmission systems, and in particular to pilot signals.

### BACKGROUND

Wireless communication systems, such as the third-generation (3G) of mobile telephone standards and technology are well known. Such 3G standards and technology have been developed by the Third Generation Partnership Project (3GPP). The 3^{rd} generation of wireless communications has generally been developed to support macro-cell mobile phone communications. Communication systems and networks have developed towards a broadband and mobile system.

The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

NR proposes an OFDM transmission format for the wireless link of the system. OFDM systems utilise a number of sub-carriers spaced in frequency, each of which is modulated independently. Demodulation of the set of the sub-carriers allows recovery of the signals. Time slots are defined for the scheduling of transmissions, which each slot comprising a number of OFDM symbols. NR has proposed 7 or 14 OFDM symbols per slot. The sub-carriers, or frequency resources, within each slot may be utilised to carry one or more channel over the link. Also, each slot may contain all uplink, all downlink, or a mixture of directions.

NR also proposes mini-slots (TR 38.912) which may comprise from 1 to (slot-length-1) OFDM symbols to improve scheduling flexibility. Each mini-slot may start at any OFDM symbol within a slot (provided the resources are not pre-allocated to channels, for example PDCCH). Some configurations may be limited to systems over 6 GHz, or to a minimum mini-slot length of 2 OFDM symbols.

5G proposes a range of services to be provided, including Enhanced Mobile Broadband (eMBB) for high data rate transmission, Ultra-Reliable Low Latency Communication (URLLC) for devices requiring low latency and high link reliability, and Massive Machine-Type Communication (mMTC) to support a large number of low-power devices for a long life-time requiring highly energy efficient communication.

TR 38.913 defines latency as “The time it takes to successfully deliver an application layer packet/message from the radio protocol layer 2/3 SDU ingress point to the radio protocol layer 2/3 SDU egress point via the radio interface in both uplink and downlink.” For URLLC, the target for user plane latency is 0.5 ms for uplink (UL), and 0.5 ms for downlink (DL).

TR 38.913 defines Reliability as “Reliability can be evaluated by the success probability of transmitting X bytes within a certain delay, which is the time it takes to deliver a small data packet from the radio protocol layer 2/3 SDU ingress point to the radio protocol layer 2/3 SDU egress point of the radio interface, at a certain channel quality (e.g., coverage-edge).” For URLLC, a reliability requirement for one transmission of a packet is defined as 1×10⁻⁵ for 32 bytes with a user plane latency of 1 ms.

Many legacy radio systems utilised cell-specific pilot reference symbols (RS) to allow coherent reception of data. In contrast, NR proposes the use of a specific RS for each physical channel, and no cell-specific RSs are provided. RS sequences and densities are being defined for slot-based communications in NR.

Two configurations are currently proposed for a single OFDM symbol with Demodulation Reference Signals (DMRS). FIG. 1 shows a representation of configuration 1 in which two antenna ports are multiplexed in a comb structure in the frequency design. FIG. 2 shows a representation of configuration 2 which is based on Frequency-Domain (FD) orthogonal covers codes (OCC) of adjacent Resource Elements (RE), which can support up to 6 antenna ports.

In both configurations all resources of the OFDM symbol are utilised for the DMRS with the maximum number of supported antenna ports. For 2 antenna ports all resources are used for configuration 1, 1/3 of the resources are used for type 2 (which uses 2/3 of the resources for 4 antenna ports). Such resource consumption may be appropriate when the DMRS is for a slot, but is a large portion of resources for a mini-slot which can be as short as 1 OFDM symbol. The RS overhead is thus very large due to the current intention of an RS per physical channel.

FIG. 3 shows a specific example of mini-slots demonstrating the DMRS overhead. It can be seen that a mini-slot of two OFDM symbols has a 50% DMRS overhead if the DMRS uses all frequency resources in the respective OFDM symbol.

The examples of FIG. 3 highlight the overhead incurred by requiring a DMRS for each channel. Furthermore, the transmission of DMRS at the start of each mini-slot removes any flexibility to adapt the transmission frequency to channel or system conditions. For example, a rapidly changing channel may require more frequent transmission of DMRS to ensure continued synchronisation.

There is therefore a requirement for an improved RS structure.

The present invention is seeking to solve at least some of the outstanding problems in this domain.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a method of downlink data transmission from a base station to a UE in a cellular communication system utilising an OFDM modulation format, the method comprising the steps of defining a DMRS transmission pattern for a mini-slot such that a DMRS is transmitted in a plurality of OFDM symbols in the mini-slot; and transmitting the mini-slot including the defined DMRS pattern from the base station to the UE.

The DMRS transmission pattern in a mini-slot may be transmitted to the UE in an associated DCI.

The DCI may be transmitted on the PDCCH of the slot in which the mini-slot is positioned.

The DCI may be transmitted on a PDCCH which is part of the mini-slot.

The DMRS transmission pattern may be transmitted to the UE using higher layer signalling, in particular RRC signalling.

The DMRS transmission pattern may be described as an indication of periodicity.

The DMRS transmission pattern may be indicated by reference to a table of transmission patterns.

A transmission pattern may be selected from the table of transmission patterns according to configuration of the system.

There is also provided a method of downlink data transmission from a base station to a UE in a cellular communication system utilising an OFDM modulation format, the method comprising the steps of defining a DMRS for transmission on an OFDM symbol of a mini-slot, wherein the DMRS does not utilise all frequency resources of the OFDM symbol; applying a cyclic shift to the DMRS to generate DMRS for antenna ports on which the OFDM symbol is to be transmitted, wherein a different cyclic shift is applied for each port; and transmitting mini-slots comprising the cyclically shifted DMRS through antenna ports corresponding to the applied cyclic shift.

The DMRS may use adjacent pairs of frequency resources, and wherein an orthogonal cover code is applied to each pair of adjacent frequency resources.

The spacing of the DMRS signals in the frequency domain may be transmitted from the base station to the UE.

The spacing of the DMRS signals may be transmitted in a DCI.

The spacing of the DMRS signals may be transmitted using higher layer signalling, in particular RRC signalling.

The method may comprise the step of adjusting DMRS power relative to data OFDM symbol power dependent on the proportion of resources used by the DMRS, such that the DMRS power is increased as fewer resources are utilised.

There is also provided a method of downlink data transmission from a base station to a UE in a cellular communication system utilising an OFDM modulation format, the method comprising the steps of defining a DMRS for transmission on an OFDM symbol of a mini-slot, wherein the DMRS does not utilise all frequency resources of the OFDM symbol, and wherein a subset of the frequency resources used by the DMRS apply to transmission via a first antenna port, and a second, discrete, subset of the frequency resources used by the DMRS apply to transmission via a second antenna port, such that one OFDM symbol carries DMRS for at least two antenna ports; and applying a cyclic shift to the DMRS to generate DMRS for a second set of antenna ports on which the OFDM symbol is to be transmitted.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIGS. 1 and 2 show examples of conventional DMRS signals;

FIG. 3 shows an example of mini-slots;

FIG. 4 shows an example of a DMRS with cyclic shifts;

FIG. 5 shows an example of a DMRS with cover codes and cyclic shifts; and

FIG. 6 shows an example of a DMRS with cyclic shifts.

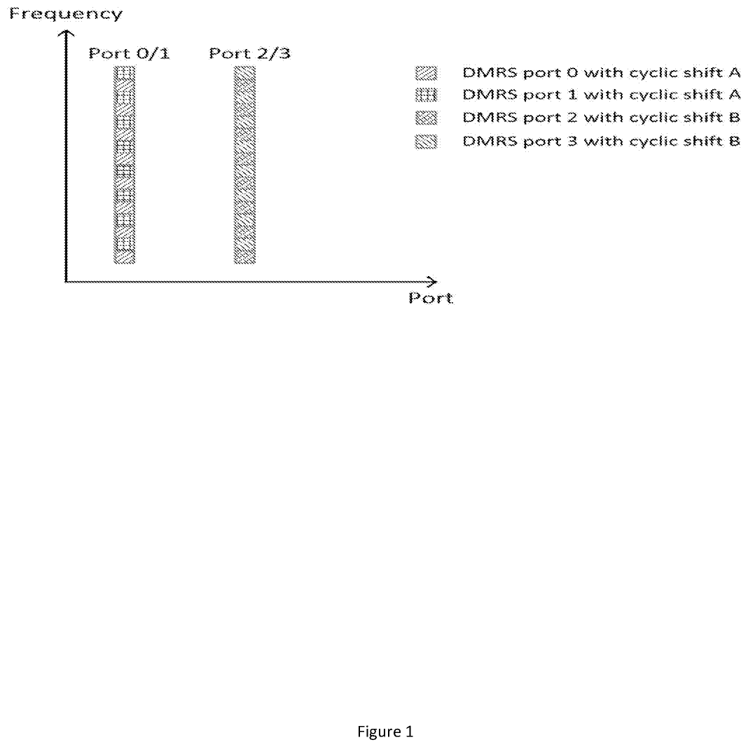

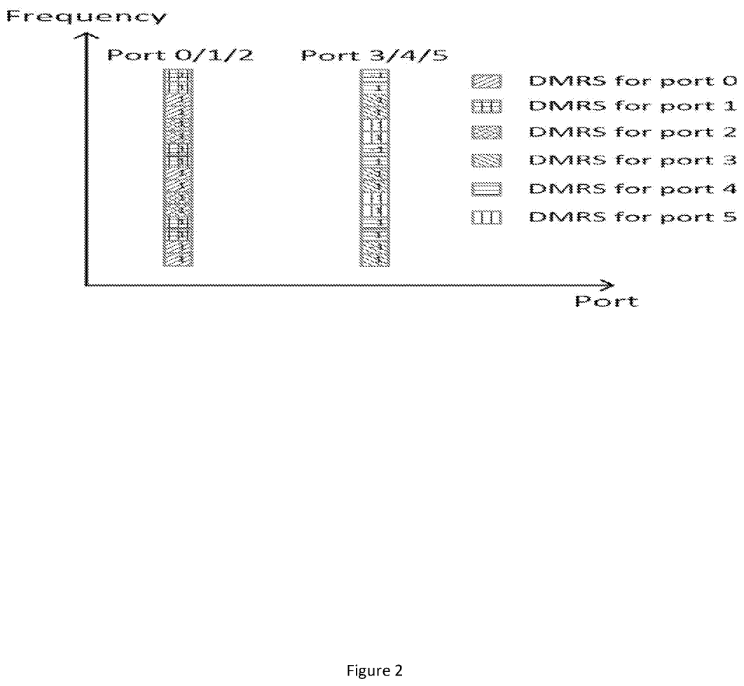

### DETAILED DESCRIPTION OF THE PREFERRED EMBODIMENTS

Those skilled in the art will recognise and appreciate that the specifics of the examples described are merely illustrative of some embodiments and that the teachings set forth herein are applicable in a variety of alternative settings.

The following disclosure provides a means to improve the spectral efficiency of DMRS transmission in mini-slots using a range of transmission techniques. In the frequency domain (a) different cyclic shifts per antenna port, (b) frequency domain orthogonal cover codes and cyclic shifts, and (c) frequency domain multiplexing and cyclic shifts are considered. In the time domain methods are provided to control the frequency of DMRS transmission to adapt to channel and system conditions.

The following description is given in the context of a cellular communication system, comprising land-based network components and remote User Equipment (UE). In particular reference is made to a wireless channel between a base station of the land-based network and the UE. Transmissions from the base station to the UE are in the downlink direction, and transmissions from the UE to the base station are in the uplink direction. The base station may comprise, or be connected to, a gNB which performs network management and control functions.

The frequency of DMRS transmission may be adapted by allowing multiple DMRS to be sent in a mini-slot. In order to control this the gNB may select a periodicity for transmissions. An indication of the periodicity may be transmitted to UEs in a DCI indicating how frequently DMRS can be expected. The periodicity can also be configured semi-statically, for example using higher layer (RRC) signalling to avoid increasing the DCI payload.

The following table shows an example of a configuration table that may be utilised to define the periodicity:

Message payload

| | 0 | 1 | 2 | 3 |
|---|---|---|---|---|
| DMRS Periodicity | 0 | 2 | 3 | 4 |

After receipt of the message payload (in DCI or higher layer signalling) a UE will assume that mini-slots contain DMRS at the indicated periodicity. For example, if the UE receives the payload “2” DMRS can be expected in at symbols 0, 3, 6, 9 etc.

In an alternative arrangement look-up tables may be defined containing DMRS positions for mini-slots of different lengths. Multiple tables may be provided to provide different behaviour in different circumstances. For example, a table for a fast-moving UE may be provided:

| Length of mini-slot | 1 | 2 | 3 | 4 | 5 | 6 |
|---|---|---|---|---|---|---|
| DMRS position | 0 | 0 | 0 | 0, 2 | 0, 3 | 0, 2, 4 |

In addition a table for a slow-moving UE may also be provided:

| Length of mini-slot | 1 | 2 | 3 | 4 | 5 | 6 |
|---|---|---|---|---|---|---|
| DMRS position | 0 | 0 | 0 | 0 | 0 | 0, 3 |

A signal indicating which table to utilise may be sent in the DCI, or configured semi-statically in higher layer signalling.

Furthermore, other parameters may affect the desired periodicity, for example the sub-carrier spacing:

| Length of mini-slot | 1 | 2 | 3 | 4 | 5 | 6 |
|---|---|---|---|---|---|---|
| DMRS position | 0 | 0 | 0 | 0, 3 | 0, 3 | 0, 3 |
| SCS = 15 kHz | | | | | | |
| DMRS position | 0 | 0 | 0 | 0, 2 | 0, 3 | 0, 2, 4 |
| SCS = 30 kHz | | | | | | |

The above tables are provided for example only, and as will be appreciated multi-dimensional tables, or combinations of tables, may be utilised to accommodate a range of parameters in the selection of an appropriate DMRS periodicity.

As discussed above, the current proposal for NR is for DMRS to be positioned in the first PDSCH symbol. For the currently proposed formats DMRS occupies the whole symbol if the number of ports is large. With configuration type 1 a single symbol mini-slot can only support 1 antenna port, and with configuration type 2 can support 4 antenna ports (otherwise there are no resources for data transmission). In the following disclosure varying DMRS structures are proposed below for 1-symbol mini-slots.

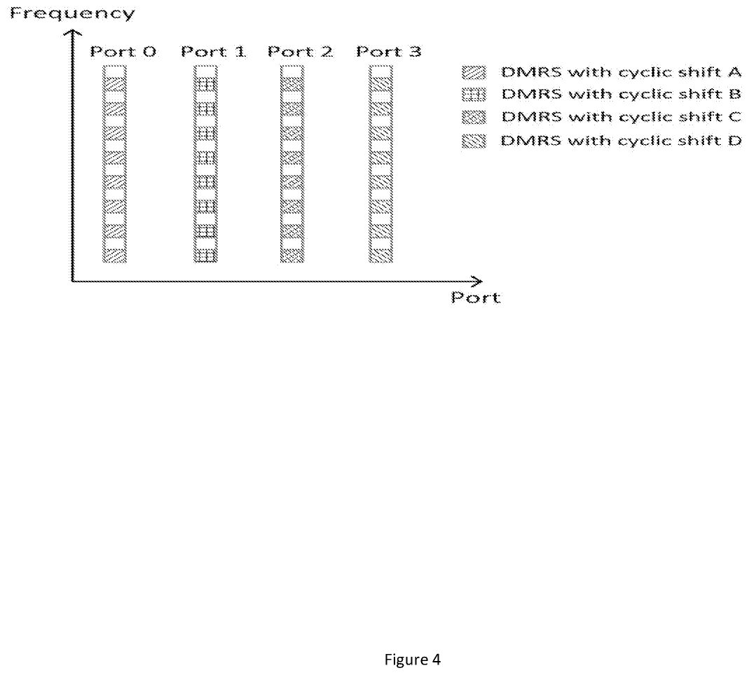

FIG. 4 shows a DMRS design for up to 4 antenna ports utilizing cyclic shifts of the DMRS sequence on each antenna port to achieve (quasi-)orthogonality. DMRS are allocated only every other resource element in the frequency domain for each antenna port. Each antenna port uses the same frequency resource elements, but a different cyclic shift is applied to the DMRS sequence for each port to achieve (quasi-)orthogonality for better channel estimation.

For four antenna ports 50% of the frequency resources in the OFDM symbol are utilised for DMRS, leaving 50% for the carriage of PDSCH or PDCCH. The principle can be extended to larger numbers of antenna ports by the selection of appropriate cyclic shifts. However, as the number of ports increases interference between DMRS of different antenna ports will also increase.

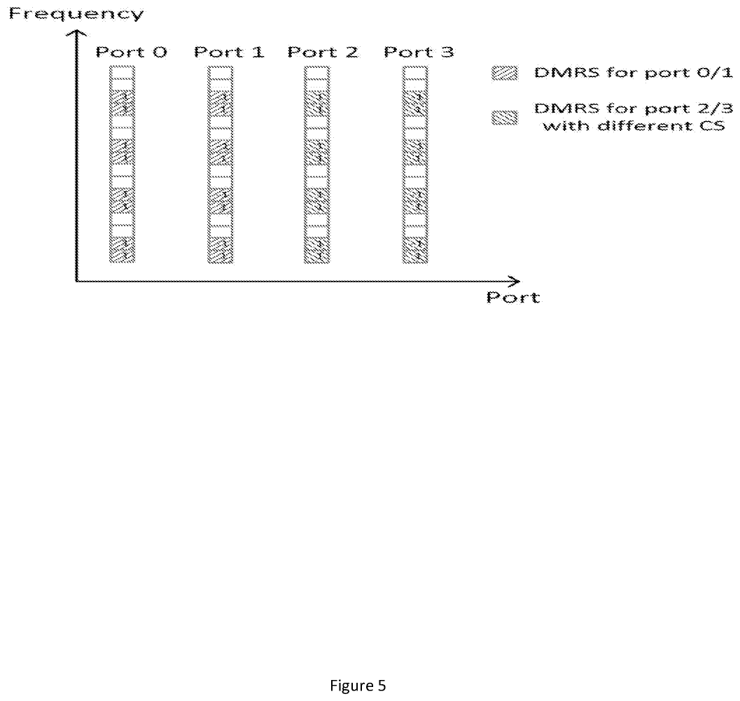

A further option is shown in FIG. 5. Here, a frequency domain orthogonal cover code over 2 adjacent frequency resource elements is utilised, with 2 cyclic shifts of the DMRS sequence for third and fourth antenna ports. As with the previous example 50% of the frequency resources are utilised for four antenna ports.

More specifically, the first two antenna ports use the same resource elements for DMRS, but antenna port 1 uses an orthogonal cover code with respect to antenna port 0. The orthogonal cover code allows the UE to estimate the channel even though both antenna ports use the same resource elements. Antenna ports 2 and 3 have the same structure, but the DMRS is cyclically shifted compared to ports 0 and 1. The two cyclically shifted DMRS are (quasi-)orthogonal.

The configuration of FIG. 5 is an example only and the DMRS can be shifted in frequency domain and an OCC of (−1,1) can be used instead of (1,−1). Moreover, this system can be extended to 8 or more antenna ports by utilizing more cyclical shifts of the DMRS. For example, 8 antenna ports can be supported with 4 cyclically shifted DMRS or 12 antenna ports with 6 cyclically shifted DMRS.

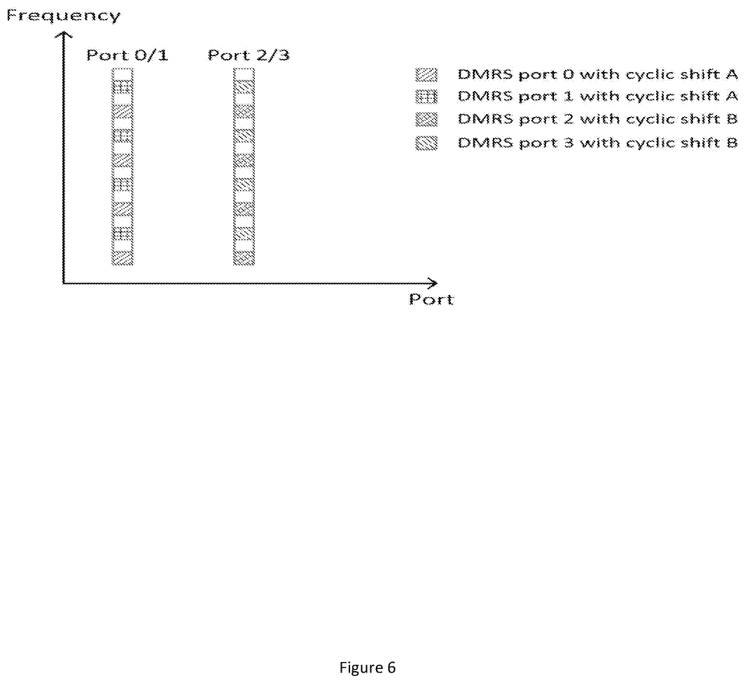

In situations where the wireless channel does not suffer significant frequency selectivity the spacing of DMRS for each port in the frequency domain can be increased compared to the examples of FIGS. 4 and 5. In FIG. 6 shows an example in which the DMRS for each port are spaced four REs apart, with two antennas ports interleaved. Different cyclic shifts of DMRS are used for each pair of antenna ports.

The arrangement of FIG. 6 utilises 50% of the frequency resources for 4 ports, but improves channel estimation due to improved orthogonality of the DMRS used for each port.

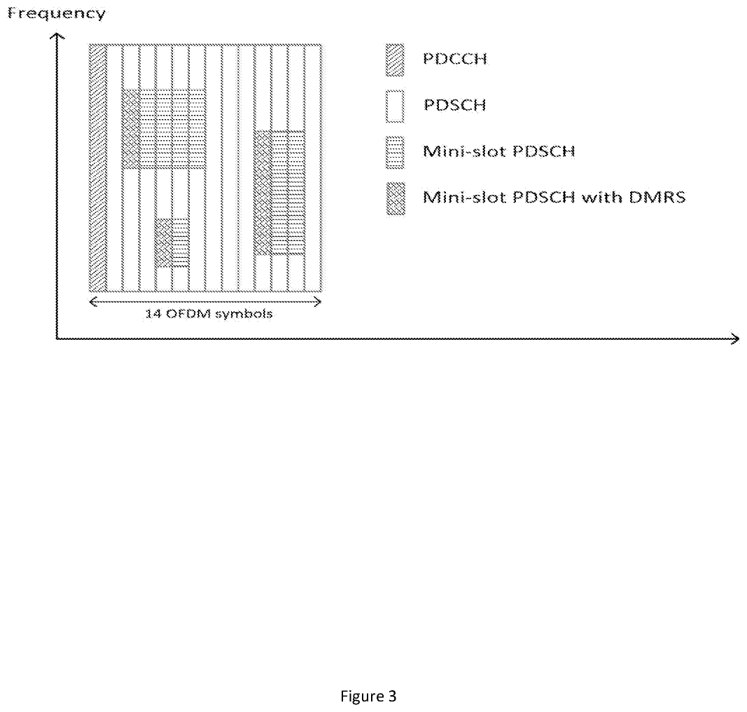

The frequency usage of the systems of FIGS. 3 to 6 may be adapted to channel conditions by varying the DMRS spacing in frequency. Such variation allows a suitable amount of DMRS to allow channel estimation, while maximising resources for data or control information.

The DMRS spacing in the frequency domain can be signalled in every DCI or can be configured semi-statically through higher layer signalling. An example of possible DMRS spacings is shown in the following table:

Message value

| | 0 | 1 | 2 | 3 |
|---|---|---|---|---|
| Example 1 | 2 | 4 | 6 | 8 |
| Example 2 | 4 | 6 | 8 | 10 |
| Example 3 | 4 | 6 | 8 | 10 |

The message value indicates the spacing to utilise for a given configuration.

The quality of channel estimation is generally related to the number of DMRSs in the frequency domain. In order to compensate for reducing the number of DMRSs the transmission power can be increased relative to the power of the data symbols. For example, halving the DMRS density can be (approximately) compensated by a 3 dB increase in transmission power of DMRS.

For mini-slots having more than one OFDM symbol the DMRS may be distributed among two or more the OFDM symbols. However, such time multiplexing may require more resources which may be needed for PDSCH or PDCCH.

Although the above description has been given with reference to downlink transmissions, all of the same principles and processes apply to the transmission of uplink signals.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory

In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ or “including” does not exclude the presence of other elements.

1.-24. (canceled)

25. A method of data transmission between a base station and a UE in a cellular communication system utilising an OFDM modulation format, the method comprising the steps of
defining a DMRS transmission pattern for a mini-slot such that a DMRS is transmitted in a plurality of OFDM symbols in the mini-slot; and
transmitting the mini-slot including the defined DMRS pattern between the base station and the UE, wherein
the DMRS transmission pattern is indicated by reference to a multi-dimensional table or a combination of tables of transmission patterns, wherein the multi-dimensional table, or at least one of the tables, are defined containing DMRS positions for mini-slots of different lengths.

26. A method according to claim 25, wherein the DMRS transmission pattern in a mini-slot is transmitted to the UE in an associated DCI.

27. A method according to claim 25, wherein the DMRS transmission pattern is transmitted to the UE using higher layer signalling, in particular RRC signalling.

28. A method according to claim 25, wherein the DMRS transmission pattern is described as an indication of multiple DMRS to be sent in a mini-slot.

29. A method according to claim 25, wherein the data transmission is a downlink data transmission and the method is performed at the base station.

30. A method according to claim 25, wherein the data transmission is an uplink data transmission and the method is performed at the UE.

31. A method of data transmission between a base station and a UE in a cellular communication system utilising an OFDM modulation format, the method comprising the steps of
defining a DMRS for transmission on an OFDM symbol of a mini-slot, wherein the DMRS does not utilise all frequency resources of the OFDM symbol;
applying a cyclic shift to the DMRS to generate DMRS for antenna ports on
which the OFDM symbol is to be transmitted, wherein a different cyclic shift is applied
for each port; and
transmitting mini-slots comprising the cyclically shifted DMRS through antenna ports corresponding to the applied cyclic shift.

32. A method according to claim 31, wherein the DMRS uses adjacent pairs of frequency resources, and wherein an orthogonal cover code is applied to each pair of adjacent frequency resources.

33. A method according to claim 31, wherein the spacing of the DMRS signals is transmitted in a DCI.

34. A method according to claim 31, wherein the spacing of the DMRS signals is transmitted using higher layer signalling, in particular RRC signalling.

35. A method according to claim 31, comprising the step of adjusting DMRS power relative to data OFDM symbol power dependent on the proportion of resources used by the DMRS, such that the DMRS power is increased as fewer resources are utilised.

36. A method according to claim 31, wherein the data transmission is a downlink data transmission and the method is performed at the base station.

37. A method according to claim 31, wherein the data transmission is an uplink data transmission and the method is performed at the UE.

38. A method according to claim 37, wherein the DMRS pattern is transmitted from the base station to the UE.

39. A method according to claim 37, wherein the spacing of the DMRS signals in the frequency domain is transmitted from the UE to the base station.

40. A method according to claim 31, wherein the spacing of the DMRS signals in the frequency domain is transmitted from the base station to the UE.
